(19) United States
(12) Patent Application Publication
(10) Pub. No.: US 2014/0129471 A1
(43) Pub. Date: May 8, 2014

(54) SYSTEMS AND METHODS FOR OPTHALMIC STAFFING

(71) Applicant: Deidre L. Howard, Seattle, WA (US)

(72) Inventor: Deidre L. Howard, Seattle, WA (US)

(21) Appl. No.: 14/153,395

(22) Filed: Jan. 13, 2014

(51) Int. Cl. G06Q 10/10; G06Q 30/02

(52) U.S. Cl. CPC G06Q 10/1053; G06Q 30/0241
USPC 705/321

(57) ABSTRACT

A computer-implemented method that can be used to select for staffing temporary ophthalmic positions is described. The method includes the steps of: providing a database configured to store information pertaining to one or more members, wherein the database is further configured to store information pertaining to one or more clients; storing member information in the database; storing client information in the database; providing to the client a calculated price or a negotiated price for the staffing opportunity; enabling selection of the staffing opportunity by one or more members, wherein these members are selecting members; enabling selection of a desired member by the client from the selecting members; and notifying the desired member of the client's selection.

### FIELD OF THE INVENTION

The present invention is directed to systems and methods for scheduling temporary staffing opportunities for opticians using the internet and web-based databases.

### BACKGROUND OF THE INVENTION

There is a niche market for filling short-term or temporary optician positions in the ophthalmic industry. Ophthalmology practices or clinics are generally run by ophthalmologists, who hold bachelors and Doctor of Medicine (M.D.) or Doctor of Osteopathic Medicine (D.O.) degrees. Optometrists, who hold bachelors and Doctor of Optometry degrees, generally diagnose and treat some eye diseases as well as prescribe and fit corrective lenses. Opticians design, fit, and dispense lenses to correct vision. The requirements to become an optician vary by state within the United States, but most states require certificate or associate degrees or the completion of a training program. However, some states, including Oregon, have no licensing requirements. There are about 20,000 optometry practices in the United States. Most optometry practices are staffed by one to two optometrists and three to four opticians.

As the ophthalmic industry is so small nationally, and the skills needed by a person to fill each temporary position are so specific, there are no temporary ophthalmic staffing companies able to operate efficiently and profitably. Most ophthalmic practices and opticians seeking part-time or temporary work currently rely on word-of-mouth to fill temporary vacancies or temporary positions. This leaves opticians desiring such work with little flexibility and freedom in employment opportunity, financial empowerment, and industry credibility, particularly in states with no licensing requirements or opticians associations. With opticians needing temporary employment reduced to relying on word-of-mouth employment opportunities, there is a need for improved temporary ophthalmic staffing methods.

### SUMMARY OF THE INVENTION

In brief, this invention is generally directed to systems and computer-implemented methods for staffing temporary ophthalmic positions, to overcome the problems of inefficient existing techniques of staffing temporary ophthalmic positions.

In one embodiment, the method for staffing temporary ophthalmic positions includes the steps of (a) providing a database configured to store information pertaining to one or more members, said database being further configured to store information pertaining to one or more clients, (b) storing member information in the database, wherein the member information includes one or more of professional skills of the member and professional experience of the member, (c) storing client information in the database, wherein the client information includes one or more of client location, desired services, desired skills, desired experience, and desired staffing times for a staffing opportunity, (d) providing to the client a calculated price or a negotiated price for the staffing opportunity, wherein the calculated price is offered to the client based on one or more of the desired services, the desired skills, and the desired experience, (e) enabling selection of the staffing opportunity by one or more members, said members being selecting members, (f) enabling selection of a desired member by the client from the selecting members; and (g) notifying the desired member of the client's selection.

In one embodiment, the system for staffing temporary ophthalmic positions comprises a first database configured to store information pertaining to one or more members, said database being further configured to store information pertaining to one or more clients requiring temporary staffing; a second database configured to store one or more reels, each reel comprising one or more advertisements, said advertisement having a link to an advertiser's product line; and a server in communication with the first database configured to carry out the method to select for staffing temporary ophthalmic positions. This embodiment may further comprise a second server in communication with the first and second databases configured to: display, on a page viewable by a user on a digital display, one or more advertisements from one or more of the reels; display on the page the advertiser's product line upon selection of the advertising link; and stop displaying the advertiser's product line upon a length of inactivity. The first and second servers may be the same server operated by a single entity or different servers operated by different entities.

The above paragraphs represent some of the more pertinent features of the present invention. These should be construed to be illustrative of some of the more prominent features and applications of the invention. A fuller understanding of the invention may be had by referring to the following Detailed Description.

### BRIEF DESCRIPTION OF THE DRAWINGS

FIG. 1A is a flow chart showing a first set of steps of an exemplary process for a member selecting a temporary ophthalmic staffing opportunity.

FIG. 1B is a flow chart showing a second set of steps of an exemplary process for a member selecting a temporary ophthalmic staffing opportunity.

FIG. 2A is a flow chart showing a first set of steps of an exemplary process for a client selecting a member to fill a temporary ophthalmic staffing opportunity.

FIG. 2B is a flow chart showing a second set of steps of an exemplary process for a client selecting a member to fill a temporary ophthalmic staffing opportunity.

FIG. 3 is a representation of a portion of a webpage showing the calendar display of staffing opportunities and advertisements.

### DETAILED DESCRIPTION OF THE INVENTION

This invention relates to novel systems for staffing temporary ophthalmic opportunities and methods to select for them. The present invention finds application in the ophthalmic industry, where there are currently no efficient methods or systems for finding available licensed dispensing opticians or other ophthalmic professionals with the appropriate qualifications to fill temporary positions in ophthalmic practices. As used herein, ophthalmic practices means ophthalmology practices, ophthalmology clinics, optometry practices, optometry clinics, and other ophthalmic service providers. In the foregoing detailed description, numbers in parentheses refer to steps of a process.

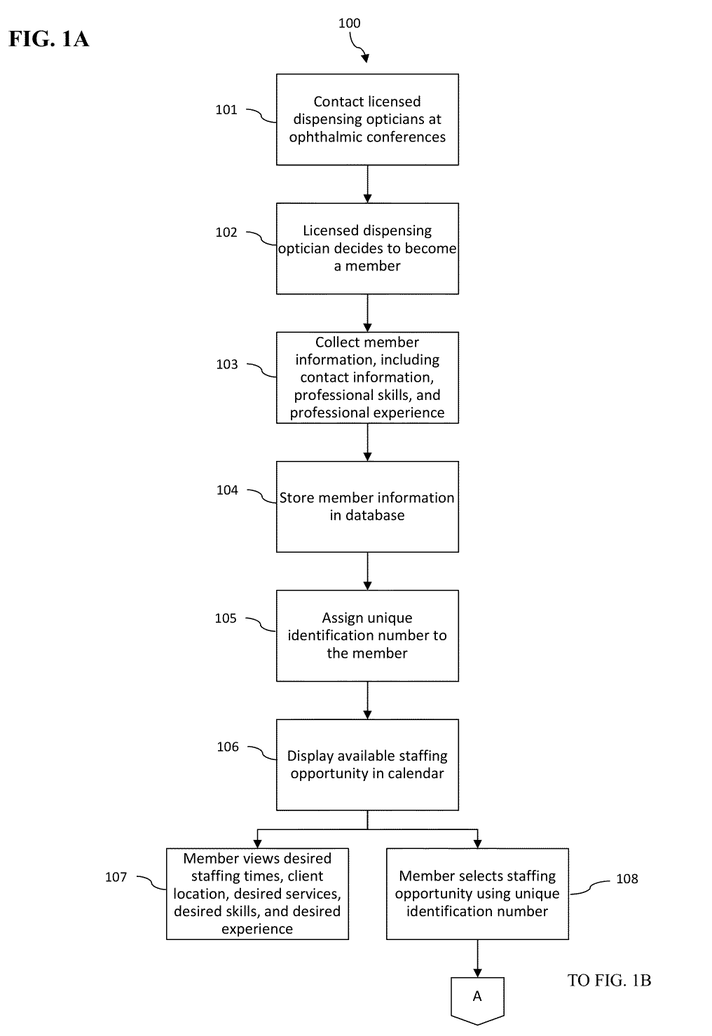

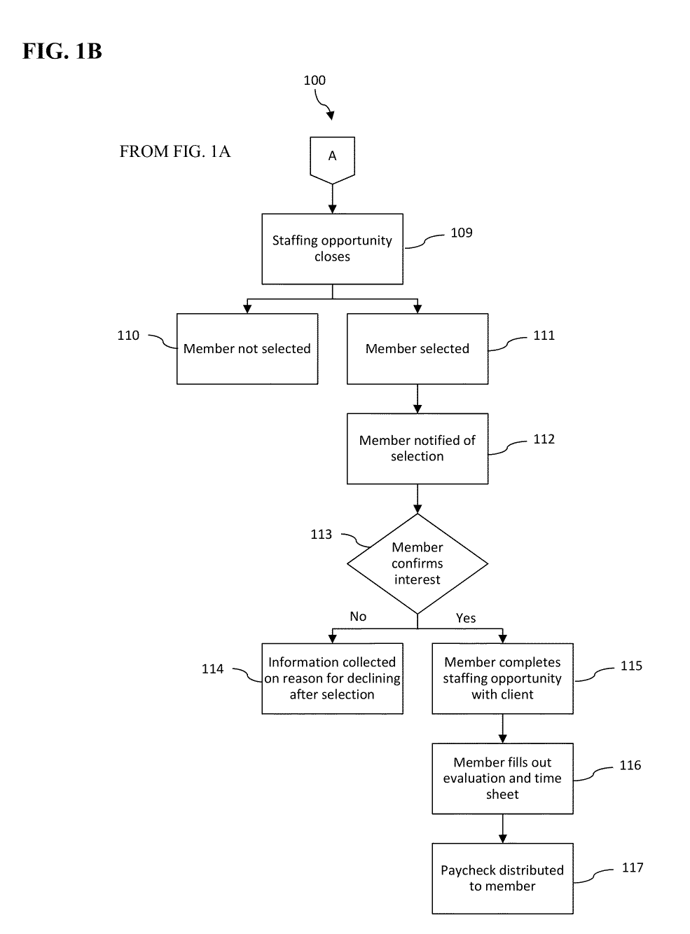

FIG. 1A is a flow chart showing a first set of steps of an exemplary process 100 for members to select a temporary ophthalmic staffing opportunity in accordance with the principles of the present invention. FIG. 1B is a flow chart showing a second set of steps of the exemplary process 100. In one embodiment, members are licensed dispensing opticians. In another embodiment, members may be optometrists or non-licensed opticians. As shown, potential members may be contacted at ophthalmic conferences 101. Potential members may also be contacted via telephone, mail, electronic mail, or any other means of communication, or may initiate communication themselves. As used herein, email means electronic mail. Once a potential member decides to become a member 102, information about that member, herein called member information, is collected 103. In one embodiment, member information is collected through a user interface on a web page. Member information may include one or more of name, member contact information, professional skills of the member, professional experience of the member, professional title, education, licenses, certification numbers, years in the field, professional achievements, professional associations, professional memberships, professional interests, any other professional biographical information, and personal information. Member contact information may include one or more of home address, work address, telephone number, email address, and any other information pertaining to contact with the member. In one embodiment, the member information is stored in a database 104. The member may be assigned a unique member identification number 105.

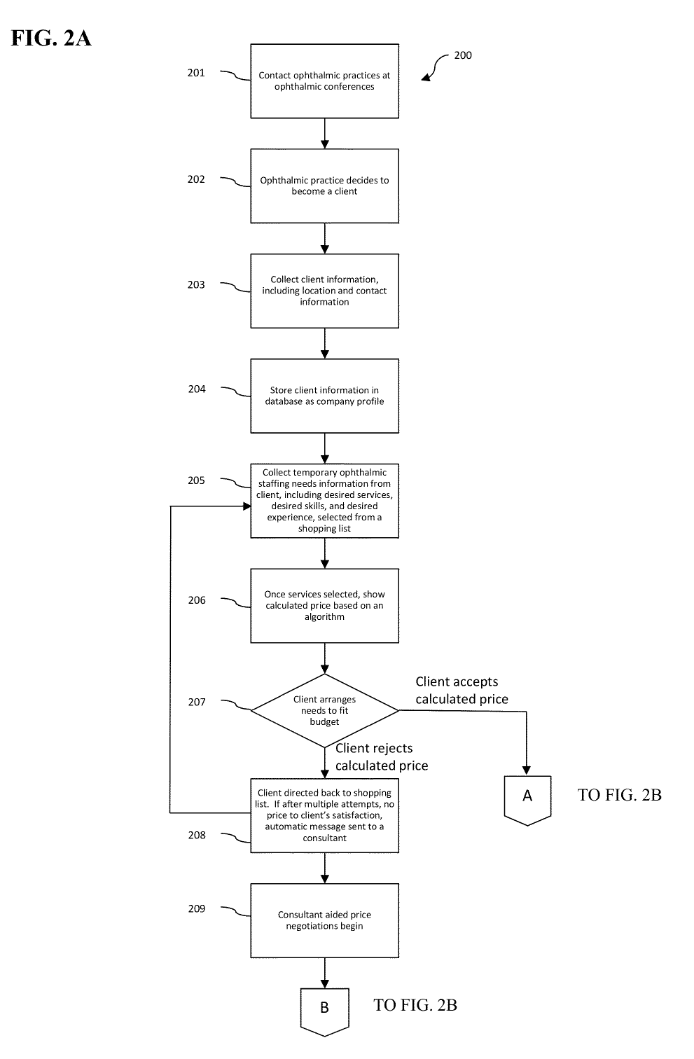

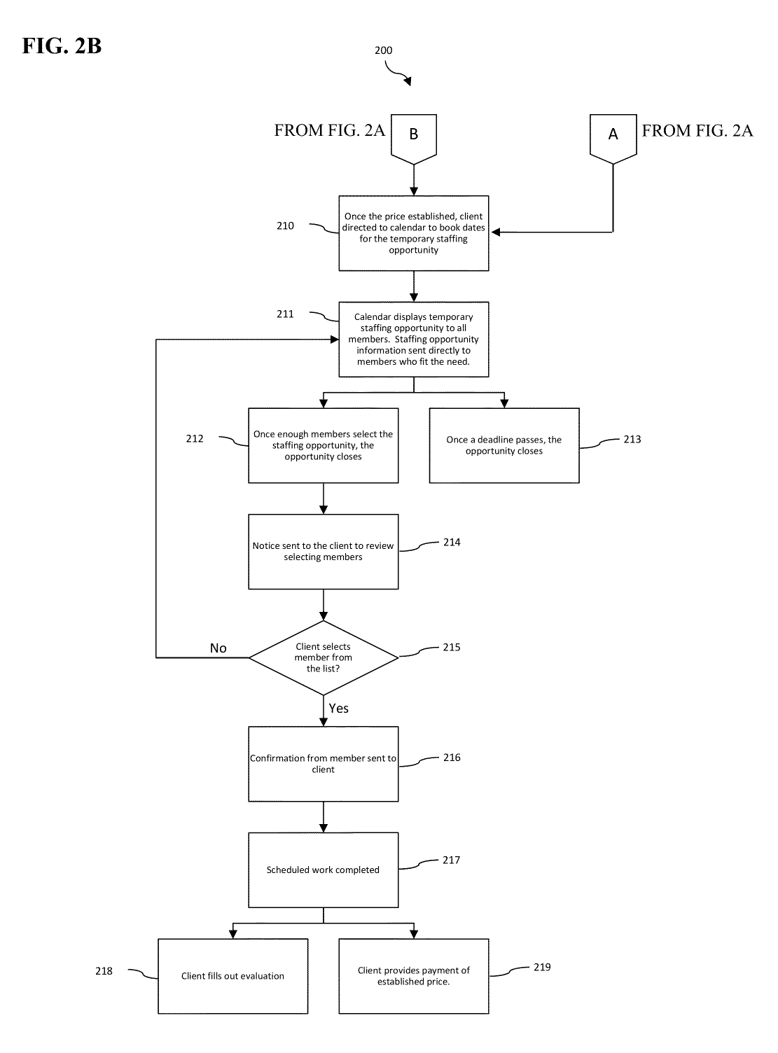

FIG. 2A is a flow chart showing a first set of steps of an exemplary process 200 for clients to select a member to fill a temporary ophthalmic staffing opportunity in accordance with the principals of the invention. FIG. 2B is a flow chart showing a second set of steps of the exemplary process 200. Clients may be ophthalmic practices requiring temporary staffing. As shown, potential clients may be contacted at ophthalmic conferences 201. Potential clients may also be contacted via telephone, mail, electronic mail, or any other means of communication, or may initiate communication themselves. Once a potential client decides to become a client 202, information about that client, herein called client information, is collected 203. In one embodiment, client information is collected through a user interface on a web page. Client information may include one or more of client location, client contact information, services offered, years of experience, and any other information about the client. Client contact information may include one or more of company name, contact name, address, telephone number, email address, and any other information pertaining to contact with the client. In one embodiment, the client information is stored in a database 204. Said database may be the same or different from the database with member information. Client information may be stored as a company profile, and may be assigned a unique client identification number. Client information may also include information about a particular temporary ophthalmic staffing opportunity, including one or more of desired services, desired skills, desired experience, and desired staffing times for the staffing opportunity. In one embodiment, information about the temporary ophthalmic staffing opportunity is selected by the client from a shopping list 205, menu, or other set of options. Said shopping list, menu, or other set of options may be displayed to the client through a user interface on a web page. Said shopping list, menu, or other set of options may include one or more of desired services, desired skills, and desired experience.

In one embodiment, standard rates for ophthalmic services in one or more states are collected. Rates may differ from state to state, and between urban and rural locations within a state. Standard rates may be collected for multiple geographic areas within a single state, or for geographic areas comprising more than one state. In another embodiment, these rates are stored in the database. In a further embodiment, standard rates are collected for ophthalmic services provided by persons with one or more of particular professional skills and particular professional experience.

A calculated price is offered to the client based on one or more of the desired services, the desired skills, and the desired experience. In one embodiment, once the client selects one or more of the desired services, desired skills, and desired experience, an algorithm may calculate a price for said desired services performed by somebody with one or more of said desired skills and said desired experience in the client's geographic area based on the collected standard rates. The calculated price may be displayed to the client through a user interface on a web page 206.

The client is free to arrange one or more of desired services, desired skills, and desired experience to fit any budgetary constraints 207, and may accept or reject the calculated price. In one embodiment, the client accepts the calculated price. In another embodiment, the client rejects the calculated price and is directed back to the shopping list, menu, or other set of options 208. The client may alter one of more of the desired services, the desired skills, and the desired experiences 205. A second calculated price is offered to the client based on one or more of the desired services, the desired skills, and the desired experiences 206. The client may accept or reject the second calculated price. In a further embodiment, the client may reject a calculated price, alter one or more of the desired services, the desired skills, and the desired experiences, and be offered a calculated price, repeating steps 205, 206, and 207 of process 200, until a predetermined number of calculated prices have been generated. In one embodiment, the predetermined number of calculated prices is between two and ten. In a preferred embodiment, the predetermined number of calculated prices is three.

In a further embodiment, the client rejects all calculated prices. After the client rejects the predetermined number of calculated prices, a consultant may be notified 208. Said notification may be through email, a push notification on a computer or mobile device, a text message, or any other means of automatic notification. The consultant may initiate communications with the client to determine a negotiated price 209. Said communications may be initiated through email, telephone, online chat, or any other means of contacting the client. The consultant may aid the client in coming to an agreement regarding said negotiated price for one or more of desired services, desired skills, and desired experience.

In one embodiment, the client may identify one or more desired staffing times for the temporary ophthalmic staffing opportunity before agreeing on a calculated or negotiated price. In another embodiment, the client may identify one or more desired staffing times for the temporary ophthalmic staffing opportunity after coming to an agreement with regard to a calculated or a negotiated price. The client may identify said desired staffing times through a user interface in a calendar format 210 or any other time and date identification format on a webpage.

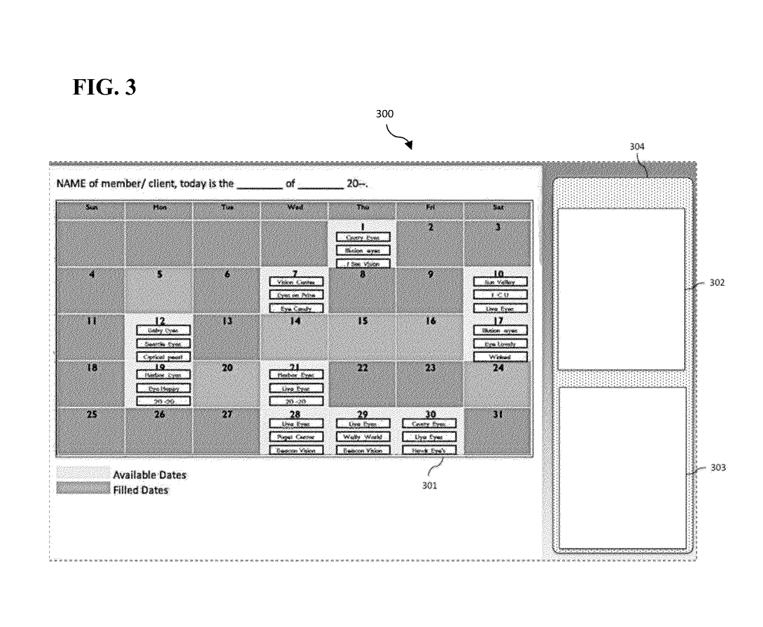

The temporary ophthalmic staffing opportunity is displayed to members. Said display may include one or more of client location, desired services, desired skills, desired experience, staffing times, and any other client or staffing opportunity information. In one embodiment, said information is displayed through a user interface in a calendar format on a webpage 211. FIG. 3 contains an example calendar format display 301. In another embodiment, one or more of the desired staffing times, the desired services, the desired skills, and the desired experience are displayed to all members 107, 211. In a further embodiment, the database is searched to find members whose member information, including one or more of professional skills of the member and professional experience of the member, match the desired skills and desired experience. Said members are notified of the staffing opportunity 211. Notification may be through email, telephone, text message, or any other communication method.

One or more members may select the staffing opportunity, said members being selecting members. In one embodiment, selecting members may use unique member identification numbers to select the staffing opportunity 108. In another embodiment, there is a maximum number of selecting members allowed for the staffing opportunity. The staffing opportunity closes once the maximum number of selecting members select the staffing opportunity 212. The maximum number of selecting members may be between one and fifty. In a preferred embodiment, the maximum number of selecting members is between two and ten. In a further preferred embodiment, the maximum number of selecting members is three.

In another embodiment, the staffing opportunity closes after a selection deadline has passed 213. The selection deadline may be set to a default time, or may be specified by the client.

After the staffing opportunity closes 212, 213, a notice may be sent to the client, allowing the client to review the member information of selecting members 214. Said notice may be through email, a notification on the client profile through a user interface on a webpage, or any other means of communication. The client may select a desired member 215. In one embodiment, the client selects a desired member from the selecting members 111. In another embodiment, the client does not select a desired member from the selecting members 110, but instead reactivates the staffing opportunity for selection by members 211. The staffing opportunity then may be deactivated after one or more members have selected the staffing opportunity 212 or after a second selection deadline has passed 213.

Once selected by the client, the desired member may be notified of selection 112. Said notification may be through email, telephone, text message, or any other means of communication. In one embodiment, the member may decline the staffing opportunity after selection, and information is collected on the reason for declining 114. In another embodiment, the member may respond to the notification, confirming interest in the staffing opportunity 113. The confirmation may further be sent to the client 216. The member may complete the staffing opportunity with the client 115. Upon completion of the staffing opportunity 217, a record of hours worked is collected. Said record may be in the form of a time sheet 116. The member may fill out an evaluation of the client 116. The client may also fill out an evaluation of the member 218. A payment is distributed to the member after completion of the staffing opportunity 117. In one embodiment, the calculated or negotiated price may be collected from the client upon completion of the staffing opportunity 219. In another embodiment, the calculated or negotiated price may be collected from the client after a desired member is selected 215 but prior to completion of the staffing opportunity 217.

FIG. 3 is a representation of an exemplary user interface 300 on a webpage displaying the calendar format 301. The user interface on the webpage may have an area dedicated to advertising 304. The area 304 may have one or more locations 302 and 303 dedicated to the display of advertisements.

To find advertisements, a sales team may compile a list of potential advertisement clients from ophthalmic industry publications, ophthalmic industry conferences, or any other sources. Potential advertisement clients may be product manufacturing companies, including one or more of eyeglass frame manufacturers, ophthalmic equipment manufacturers, and other manufacturers of products relevant to the ophthalmic industry. The list may be stored in an advertiser database. The list may further contain information about the product manufacturing companies, including one or more of company name, location, executives, marketing contact name, marketing contact number, email, company website, and any other relevant information. The sales team may study the list to choose which target to pursue, plan an approach, and enter budget projections into the advertiser database. A sales team lead may approve or deny the plan and budget. If approved, the sales team may form an advertisement proposal, and pitch the advertisement proposal to the potential advertisement client.

The potential advertisement client may accept or deny the advertisement proposal. The potential advertisement client's response may be recorded in the advertiser database. An evaluation of the advertisement proposal may be completed and recorded in the advertiser database. If the potential advertisement client accepts the advertisement proposal, the potential advertisement client is an advertisement client. As used herein, advertiser means advertisement client. The sales team may negotiate an advertising agreement with the advertiser, and record the terms of the advertising agreement in the advertiser database.

The terms of the advertising agreement may include one or more of the duration of the advertising agreement, the period of display of each advertisement, the geographical advertisement display regions, the advertisement display locations, the advertisement price or cost, and any other relevant terms. The duration of the advertising agreement will generally be a period of months, but may be shorter or longer. The period of display of each advertisement will generally be a period of seconds, but may be shorter or longer. The geographical advertisement display regions may consist of a single state, a geographical region within a single state, or geographical regions spanning more than one state. The advertisement display location may be on a page viewable by a user on a digital display. The page may be a webpage or a portion of a webpage, such as 304. In one embodiment, the digital display also displays one or more steps of the method to select for staffing temporary ophthalmic positions. In another embodiment, the digital display is a touchscreen device. The touchscreen device may be a tablet, laptop computer, phone, or other portable computing device that allows the user to interact by touching areas on the screen.

The user may be a member, a client, or a customer of the client (e.g., an ophthalmic practice). In one embodiment, the page is displayed to members. In another embodiment, the page is displayed to clients. In a further embodiment, the page is displayed to both members and clients. In a further embodiment, the page is displayed to customers at an ophthalmic practice.

Once both parties agree on all terms and sign the advertising agreement, the advertisement may be prepared by the advertiser, a marketing agency, or another source. The advertisement may include one or more of graphics, still images, moving images, words, and advertising links. The advertising links may be a web links, uniform resource locator (URL) links, or any other links. When clicked or selected, the advertising link may connect the user to the advertiser's product line. The advertiser's product line may be displayed on the page. Upon a predetermined length of inactivity, the advertiser's product line may stop being displayed. Inactivity may mean that there is no interaction between the user and the page. The predetermined length of inactivity may be a time from about five seconds to about 120 seconds. As used herein, about means ten percent of the value. Unlike typical online advertising systems, the present invention will not allow direct online consumer purchasing through the display of the advertiser's product line.

The display of the advertiser's product line may further have a communications link associated with it. In one embodiment, selection of the communications link may send a product interest message to the client, particularly where the user is a customer at an ophthalmic practice. The product interest message may be an email or text generated on an electronic messaging server, or other electronic communication. In another embodiment, selection of the communications link sends a sales inquiry message to a sales representative associated with the advertiser's product line, particularly where the user is a member or a client. The sales inquiry message may be a voice generated by a voice robot, email, text, or fax generated on an electronic messaging server, or other electronic communication, sent using a communication identifier stored in the advertiser database. The communication identifier may be an email address, telephone address, text message address, fax address, or other electronic address capable of receiving electronic communication.

The advertisement may be slotted into one or more reels depending on the terms of the agreement. A reel may consist of one or more advertisements from one or more advertisers. Each advertisement display location, such as 302 and 303, may display advertisements from a single reel. In one embodiment, advertisements from two or more reels are displayed simultaneously. In the exemplary web page portion represented in FIG. 3, advertisements from two reels are displayed simultaneously, one in location 302 and another in location 303. One reel, a member reel, may contain advertisements for display only to members in a geographical area. Another reel, a client reel, may contain advertisements for display only to clients in a geographical area. Another reel, a combined reel, may contain advertisements for display to both clients and members in a geographical area. Another reel, a lobby reel, may contain advertisements for display to customers at ophthalmic practices in a geographical area.

Each advertisement from a reel may have associated with it a constraint on a period of display of the advertisement. The constraint may be determined as one of the terms of the advertising agreement. In one embodiment, the constraint limits the period of display for a time from about two to about 20 seconds. In a preferred embodiment, the constraint limits the period of display for a time from about five to about 13 seconds.

Once the period of display of the advertisement is completed, a second advertisement from the reel may be displayed. In this manner, the advertisements from a reel may rotate through one advertisement display location.

The touchscreen device may display one or more lobby reels simultaneously. In one embodiment, a second server may be further configured to display a second advertisement from the same or different reel(s). Users viewing the lobby reel(s) on the touchscreen device may be limited to one or more of the following operational functions: touch, pause, go backward, go forward, and contact. Touch may allow the user to select the advertising link. Pause may interrupt the rotation of advertisements from the lobby reel(s), increasing the current period of display for the currently displayed advertisements for a time from about 30 seconds to about five minutes. Go backward may temporarily reverse the rotation of the reel(s), causing the previously displayed advertisement(s) to be displayed again. Go forward may artificially abruptly end the period of display of the current advertisement(s), allowing the immediate display of a second advertisement from each reel. Contact may allow an ophthalmic practice to send a sales inquiry message to a sales representative associated with the advertiser's product line.

The reels may be stored in an advertisement database. The advertisement database may be located on the same server as the member and client information or a different server. Additionally, the one or two servers may be operated by a single entity or different entities. In one embodiment, a server in communication with the database containing member and client information and with the advertisement database may be configured to display, on a page viewable by a user on a digital display, the one or more advertisements from one or more of the reels, display on the page the advertiser's product line upon selection of the advertising link, and stop displaying the advertiser's product line upon a length of inactivity. In a further embodiment, the advertisements from two or more reels are displayed simultaneously.

1. A computer-implemented method to select for staffing temporary ophthalmic positions comprising the steps of:
a. providing a database configured to store information pertaining to one or more members, said database being further configured to store information pertaining to one or more clients;
b. storing member information in the database, wherein the member information includes one or more of professional skills of the member and professional experience of the member;
c. storing client information in the database, wherein the client information includes one or more of client location, desired services, desired skills, desired experience, and desired staffing times for a staffing opportunity;
d. providing to the client a calculated price or a negotiated price for the staffing opportunity, wherein the calculated price is offered to the client based on one or more of the desired services, the desired skills, and the desired experience;
e. enabling selection of the staffing opportunity by one or more members, said members being selecting members;
f. enabling selection of a desired member by the client from the selecting members; and
g. notifying the desired member of the client's selection.

2. The method of claim 1, where the client declines the calculated price, further comprising the steps of:
a. allowing the client to alter one or more of the desired services, the desired skills, and the desired experiences; and
b. offering to the client a second calculated price.

3. The method of claim 2, further comprising the steps of:
a. repeating steps a and b of claim 2 until a predetermined number of calculated prices have been generated;
b. allowing the client to decline all calculated prices; and
c. sending a message to a consultant, said consultant initiating communications with the client to determine the negotiated price for the desired services.

4. The method of claim 1, wherein enabling selection of the staffing opportunity by one or more members further comprises the steps of:
a. searching the database for members whose member information match one or more of the desired skills and the desired experience, and notifying said members of the staffing opportunity;
b. displaying to all members one or more of the desired staffing times, the client location, the desired services, the desired skills, and the desired experience; and
c. deactivating the staffing opportunity after a one or more members have selected the staffing opportunity or after a first selection deadline has passed.

5. The method of claim 4, wherein one or more of the desired staffing times, the client location, the desired services, the desired skills, and the desired experience are displayed in a calendar format.

6. The method of claim 1, further comprising the steps of:
a. allowing the client to review the member information of selecting members; and
b. allowing the client to select a desired member from the selecting members or reactivate the staffing opportunity for selection by members.

7. The method of claim 6, where the staffing opportunity is reactivated, further comprising the steps of:
a. displaying to all members one or more of the desired staffing times, the client location, the desired services, the desired skills, and the desired experience; and
b. deactivating the staffing opportunity after one or more members have selected the staffing opportunity or after a second selection deadline has passed.

8. The method of claim 1, further comprising collecting, upon completion of the staffing opportunity, a record of hours worked.

9. The method of claim 8, further comprising distributing a payment to the member selected by the client.

10. The method of claim 8, further comprising collecting the calculated or the negotiated price from the client.

11. A system for staffing temporary ophthalmic positions, comprising:
a. a first database configured to store information pertaining to one or more members, said database being further configured to store information pertaining to one or more clients requiring temporary staffing;
b. a second database configured to store one or more reels, each reel comprising one or more advertisements, said advertisement having a link to an advertiser's product line; and
c. a server in communication with the first database configured to carry out the method of claim 1.

12. The system of claim 11, further comprising:
a second server in communication with the first and second databases configured to:
i. display, on a page viewable by a user on a digital display, one or more advertisements from one or more of the reels;
ii. display on the page the advertiser's product line upon selection of the advertising link; and
iii. stop displaying the advertiser's product line upon a length of inactivity.

13. The system of claim 12, wherein the first and second servers are the same server operated by a single entity or different servers operated by different entities.

14. The system of claim 12, wherein the advertisements from two or more of the reels are displayed simultaneously.

15. The system of claim 12, wherein each advertisement may have associated with it a constraint on a period of display of the advertisement.

16. The system of claim 15, wherein the constraint limits the period of display to a time from about 5 to about 13 seconds.

17. The system of claim 12, wherein the user is a member, a client, or a customer of the client.

18. The system of claim 12, further comprising a communications link associated with the advertiser's product line.

19. The system of claim 18, wherein the communications link comprises a product interest message to the client.

20. The system of claim 18, wherein the communications link comprises a sales inquiry message to a sales representative associated with the advertiser's product line.
